(19) United States
(12) Patent Application Publication
(10) Pub. No.: US 2026/0195095 A1
(43) Pub. Date: Jul. 9, 2026

(54) ARTIFICIAL INTELLIGENCE ACCELERATOR AND METHOD FOR OPERATING THE SAME

(71) Applicants: TAIWAN SEMICONDUCTOR MANUFACTURING COMPANY, LTD., Hsinchu (TW); NATIONAL TSING HUA UNIVERSITY, Hsinchu City (TW)

(72) Inventors: Win-San KHWA, Taipei City (TW); Yu-Chen CHEN, Taipei City (TW); Ping-Chun WU, Taichung City (TW); Ashwin Sanjay LELE, San Jose, CA (US); Bo ZHANG, San Jose, CA (US); Ping-Sheng WU, Hsinchu City (TW); Meng-Fan CHANG, Taichung City (TW)

(73) Assignees: TAIWAN SEMICONDUCTOR MANUFACTURING COMPANY, LTD., Hsinchu (TW); NATIONAL TSING HUA UNIVERSITY, Hsinchu City (TW)

(21) Appl. No.: 19/203,344

(22) Filed: May 9, 2025

Related U.S. Application Data
(60) Provisional application No. 63/741,604, filed on Jan. 3, 2025.

(51) Int. Cl. G06F 7/544

(52) U.S. Cl. CPC G06F 7/5443

(57) ABSTRACT

A circuit is provided. The circuit comprises a shared scale pre-process circuit, a first partial multiply-and-accumulate (MAC) circuit, a second partial MAC circuit and an accumulate circuit. The shared scale pre-process circuit comprises first adders configured to performs first additions between a plurality of shared scales of inputs and weights, in which the shared scale pre-process circuit generates a flag indicating a variance corresponding to results of the first additions. The first partial MAC circuit performs first mantissa alignments according to the flag for generating a first partial MAC result. The second partial MAC circuit performs second mantissa alignments according to the flag for generating a second partial MAC result. The accumulate circuit accumulates the first and second partial MAC results to generate a MAC result.

### CROSS REFERENCE

The present application claims priority to U.S. Provisional Application No. 63/741,604, filed on Jan. 3, 2025, which is herein incorporated by reference in its entirety.

### BACKGROUND

Artificial intelligence (AI) including machine learning (ML) is widely used in many cognitive tasks, such as image classification and speech recognition. For the efficient processing of workloads of such tasks, hardware has developed to have specific features for AI, e.g., specialized dataflow, compute-in-memory (CIM) architecture and near-memory computing (NMC) architecture. Such specifically designed hardware is referred to as an AI accelerator. With the increasing need of AI application, research on AI accelerators has gained more attention over the years.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a block of the MX format, in accordance with various embodiments of the present disclosure.

FIG. 2 is a schematic diagram showing an AI accelerator, in accordance with various embodiments of the present disclosure.

FIG. 3 is a schematic diagram showing an example of the computing circuit of the AI accelerator in FIG. 2, in accordance with various embodiments of the present disclosure.

FIG. 4 is a schematic diagram showing an example of the computing circuit in FIGS. 2-3, in accordance with various embodiments of the present disclosure.

FIG. 5 is a flowchart diagram of a method for operating the shared scale pre-process circuit as shown in FIGS. 3-4 in accordance with some embodiments of the present disclosure.

FIG. 6 is a flowchart diagram of a method for operating the block-wise MAC circuit as shown in FIGS. 3-4 in accordance with some embodiments of the present disclosure.

FIG. 7 is a schematic diagram of an example of a computing circuit configured with respect to the computing circuit in FIGS. 2-6, in accordance with various embodiments of the present disclosure.

FIG. 8 is a schematic diagram of an example of a computing circuit configured with respect to the computing circuits in FIGS. 2-7, in accordance with various embodiments of the present disclosure.

FIG. 9 is a schematic diagram of an example of a computing circuit configured with respect to the computing circuits in FIGS. 2-7, in accordance with various embodiments of the present disclosure.

FIG. 10 is a schematic diagram of an example of a computing circuit configured with respect to the computing circuits in FIGS. 2-9, in accordance with various embodiments of the present disclosure.

FIG. 11 is a schematic diagram of an example of a computing circuit configured with respect to the computing circuits in FIGS. 2-10, in accordance with various embodiments of the present disclosure.

FIG. 12 is a flowchart diagram of a method for operating the AI accelerator and the computing circuits in FIGS. 2-11, in accordance with some embodiments of the present disclosure.

### DETAILED DESCRIPTION

The following disclosure provides many different embodiments, or examples, for implementing different features of the provided subject matter. Specific examples of components, materials, values, steps, arrangements or the like are described below to simplify the present disclosure. These are, of course, merely examples and are not intended to be limiting. Other components, materials, values, steps, arrangements or the like are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact.

The terms applied throughout the following descriptions and claims generally have their ordinary meanings clearly established in the art or in the specific context where each term is used. Those of ordinary skill in the art will appreciate that a component or process may be referred to by different names. Numerous different embodiments detailed in this specification are illustrative only, and in no way limits the scope and spirit of the disclosure or of any exemplified term.

It is worth noting that the terms such as “first” and “second” used herein to describe various elements or processes aim to distinguish one element or process from another. However, the elements, processes and the sequences thereof should not be limited by these terms. For example, a first element could be termed as a second element, and a second element could be similarly termed as a first element without departing from the scope of the present disclosure.

In the following discussion and in the claims, the terms “comprising,” “including,” “containing,” “having,” “involving,” and the like are to be understood to be open-ended, that is, to be construed as including but not limited to. As used herein, instead of being mutually exclusive, the term “and/or” includes any of the associated listed items and all combinations of one or more of the associated listed items.

Microscaling (MX) format, also referred to as MX-compliant format, is a numerical format proposed under the open web foundation (OWF) modified contributor license agreement. Such standardized format prevents the need of customized solution for different hardware and helps reduce cost in software and infrastructure.

The present disclosure is related to an AI accelerator supporting MX format. Compared with some AI accelerators supporting only integer (INT) and/or floating-point format, an AI accelerator supporting MX format performs AI training and inference with lower bit-width arithmetic operations and smaller memory footprints.

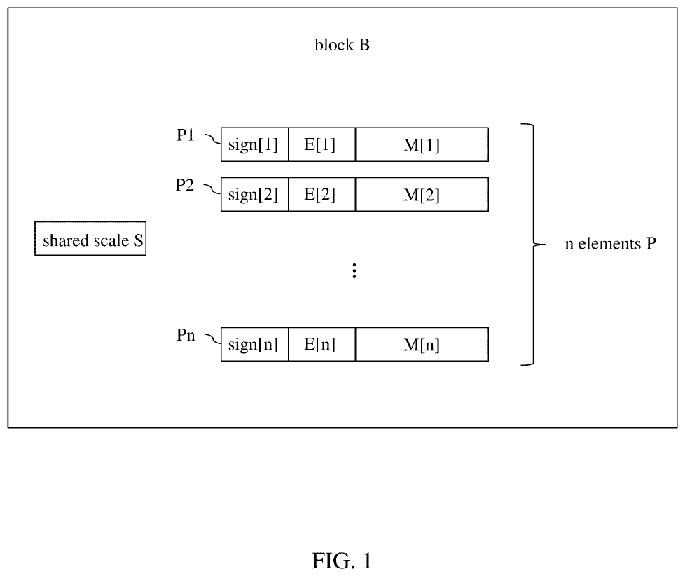

Reference is now made to FIG. 1. FIG. 1 depicts an example of a block of the MX format, in accordance with various embodiments of the present disclosure. For ease of understanding, throughout the various views and illustrative embodiments, like annotations and reference numbers are used to designate like elements.

According to some embodiments, a MX format is characterized by three components: element, shared scale and block size. Specifically, a block B of the MX format includes multiple elements P and a shared scale S shared across all the elements P. The block size refers to the quantity of the element P. For example, as shown in FIG. 1, the block B including elements P1 to Pn has a block size of “n”, in which “n” is a positive integer.

In some embodiments, all elements P have a same datatype and a same bit-width. For example, each of the elements P1 to Pn may be a floating-point number with eight bits. As shown in FIG. 1, each of the elements P1 to Pn is a floating-point number with a sign, an exponent and a mantissa. For example, the element P1 has a sign annotated as sign[1], an exponent E[1] and a mantissa M[1].

In practice, bit-widths of the sign, the exponent and the mantissa across the elements P1 to Pn are consistent. Specifically, the bit-widths of the signs sign[1] to sign[n] are the same. The bit-widths of the exponents E[1] to E[n] are the same. The bit-widths of the mantissas M[1] to M[n] are the same.

In some embodiments, the block B represents multiple values. Each value equals multiplication between the shared scale S and an element P. For example, the block B may represent “n” values v1 to vn, in which the value v1 equals to a multiplication between a value ssv of the shared scale S and a value pv1 of the element P1, the value v2 equals to a multiplication between a value ssv of the shared scale S and a value pv2 of the element P2, and so on.

For the case of the elements P1 to Pn being floating-point, the value of each of the elements P1 to Pn equals a multiplication between a sign value, an exponent value and a mantissa value. For example, the value pv1 of the element P1 equals a multiplication between a sign value sv1, an exponent value ev1 and a mantissa value mv1. The sign value sv1 equals “(−1)^{sign[1]}”. The exponent value ev1 equals “2^{E[1]-Ebias}”, in which the bias Ebias is a bias of exponent. The mantissa value mv1 equals “(1+M[1])”. Generally, the value pv1 can be generated through the following function: (−1)^{sign[1]}×2^{E[1]-Ebias}×(1+M[1]). The value of the elements P2 to Pn can be generated through sign values sv2 to svn, exponent value ev2 to evn and mantissa value mv2 to mvn in a similar manner.

In some embodiments, the value ssv of the shared scale S equals “2^{S-Sbias}”, in which the bias Sbias is a bias of shared scale. In this case, the value v1 equals “2^{S-Sbias}×(−1)^{sign[1]}×2^{E[1]-Ebias}×(1+M[1])”, the value v2 equals “2^{S-Sbias}×(−1)^{sign[2]}×2^{E[2]-Ebias}×(1+M[2])”, and so on.

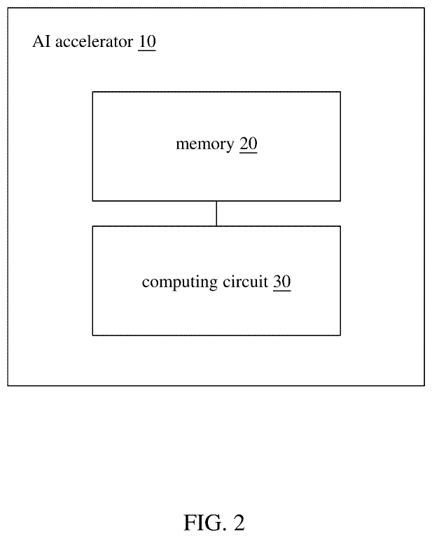

Reference is now made to FIG. 2. FIG. 2 is a schematic diagram showing an AI accelerator 10, in accordance with various embodiments of the present disclosure. The AI accelerator 10 is configured to support the MX format. In some embodiments, the AI accelerator 10 is an electronic device including integrated circuits.

For practical applications, the AI accelerator 10 may be utilized in various AI application fields such as machine vision, image classification, or data classification. For example, the AI accelerator 10 may be used for classifying medical images. For example, the AI accelerator 10 can be used to classify X-ray images in normal conditions, with pneumonia, with bronchitis, or with heart disease. The AI accelerator 10 may also be used to classify ultrasound images with normal fetuses or abnormal fetal positions. On the other hand, the AI accelerator 10 can also be used to classify images collected in automatic driving, such as distinguishing normal roads, roads with obstacles, and road conditions images of other vehicles. Furthermore, the AI accelerator 10 can be utilized in other similar fields, such like music spectrum recognition, spectral recognition, big data analysis, data feature recognition and other related AI application fields.

In some embodiments, the AI accelerator 10 includes a memory 20 and a computing circuit 30. In some embodiments, the memory 20 is coupled to the computing circuit 30.

In some embodiments, the memory 20 is configured to store weights of an AI model, for example, weights of a neural network. In some embodiments, the weights are in the MX format.

In some embodiments, the computing circuit 30 is configured to perform AI operations corresponding to the AI model, for example, an inference of the AI model.

In some embodiments, the computing circuit 30 includes a multiply-and-accumulate (MAC) circuit. In some embodiments, the computing circuit 30 performs MAC operations of the AI model, for example, the MAC operations in an inference of the AI model. In some embodiments, the computing circuit 30 performs MAC operations of data in the MX format.

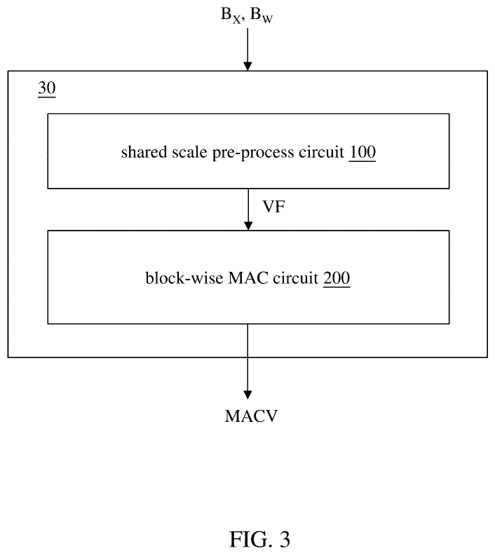

According to some embodiments, some AI models (e.g., transformer) exhibit high inter-channel variance of the distribution of products of values of shared scales in the MAC operations. This phenomenon causes computational results of operands with smaller shared scales to be truncated during the MAC operations in some approaches. However, such case of truncating the computational results would waste the energy used for computations. To reduce this wasting of energy, the computing circuit 30 is further configured to determine whether the variance of products of values of shared scales is high or low and perform the MAC operation in a specific way to reduce the truncating when the variance is determined to be high. Further details are described in the following paragraphs with reference to FIGS. 3-6.

Reference is now made to FIG. 3. FIG. 3 is a schematic diagram showing an example of the computing circuit 30 of the AI accelerator 10 in FIG. 2, in accordance with various embodiments of the present disclosure. The specific operations of similar elements, which are already discussed in detail previously, are omitted for the sake of brevity.

In some embodiments, the computing circuit 30 performs a MAC operation of inputs and weights of the AI model in the MX format. In some embodiments, the inputs of the AI model are included in multiple blocks BX of the MX format and the weights of the AI model are included in multiple blocks BW of the MX format.

In some embodiments, the blocks BX and BW are in the same MX format, e.g., MX 8-bit floating-point (MXFP8).

As shown in FIG. 3, the computing circuit 30 receives the blocks BX and the blocks BW to generate a MAC result MACV.

In the example of FIG. 3, the computing circuit 30 includes a shared scale pre-process circuit 100 and a block-wise MAC circuit 200. The shared scale pre-process circuit 100 determines whether the variance of products values of shared scales of the blocks BX and BW is high or low. Then the shared scale pre-process circuit 100 generates a flag VF indicating the variance being high or low.

The block-wise MAC circuit 200 performs a MAC operation according to the flag VF to generate the MAC result MACV. Specifically, The block-wise MAC circuit 200 adjusts the processes in the MAC operation according to the flag VF for reducing the energy consumption.

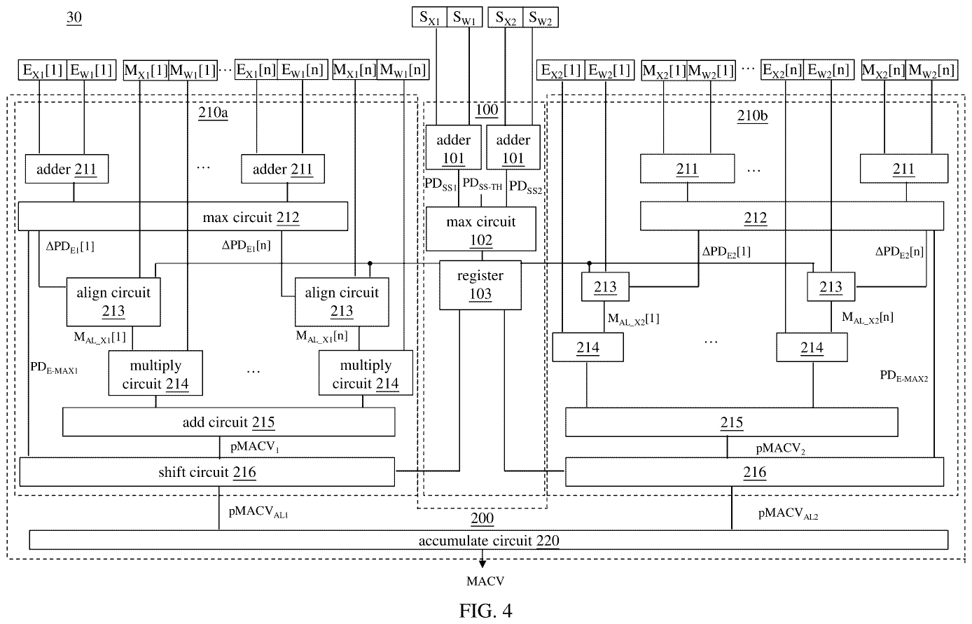

Further details of the computing circuit 30, the shared scale pre-process circuit 100 and the block-wise MAC circuit 200 are described in the following paragraphs with reference to FIG. 4.

Reference is now made to FIG. 4. FIG. 4 is a schematic diagram showing an example of the computing circuit 30 in FIGS. 2-3, in accordance with various embodiments of the present disclosure.

In the example shown in FIG. 4, the blocks B_{X} includes a block B_{X1} and a block B_{X2}. The blocks BW includes a block B_{W1} and a block B_{W2}.

In the example shown in FIG. 4, the shared scale S of the block B_{X1} is annotated as share scale S_{X1}. The elements P1 to Pn of the block B_{X1} are annotated as elements P1_{X1} to Pn_{X1} respectively. The exponents E[1] to E[n] of the block B_{X1} are annotated as exponents E_{X1}[1] to E_{X1}[n] respectively. The mantissas M[1] to M[n] of the block B_{X1} are annotated as mantissas M_{X1}[1] to M_{X1}[n] respectively.

In addition, the shared scales S, elements P1 to Pn, exponents E[1] to E[n], and mantissas M[1] to M[n] of the block B_{X2}, B_{W1}, and B_{W2} are annotated in a similar manner.

As shown in FIG. 4, in some embodiments, the shared scale pre-process circuit 100 includes adders 101, a max circuit 102 and a register 103.

In some embodiments, the block-wise MAC circuit 200 includes partial MAC circuits 210a and 210b, and an accumulate circuit 220.

In some embodiments, each of the partial MAC circuits 210a and 210b includes adders 211, a max circuit 212, align circuit 213, multiply circuits 214, an add circuit 215 and a shift circuit 216.

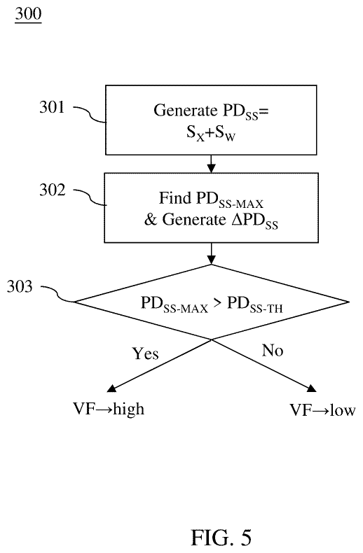

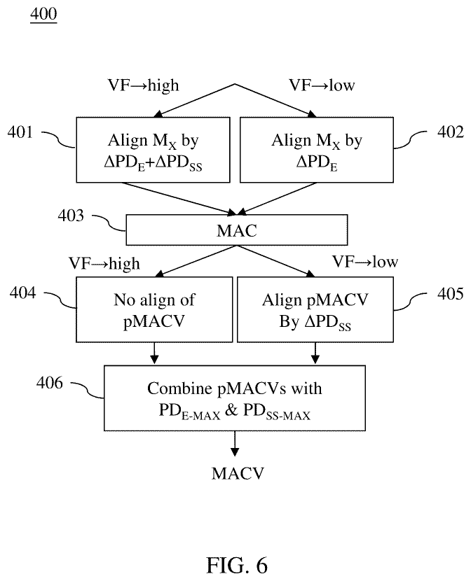

The operations of the computing circuit 30, the shared scale pre-process circuit 100 and the block-wise MAC circuit 200 are described in the following paragraphs with further reference to FIGS. 5-6.

Reference is now further made to FIGS. 5-6. FIG. 5 is a flowchart diagram of a method 300 for operating the shared scale pre-process circuit 100 as shown in FIGS. 3-4 in accordance with some embodiments of the present disclosure. FIG. 6 is a flowchart diagram of a method 400 for operating the block-wise MAC circuit 200 as shown in FIGS. 3-4 in accordance with some embodiments of the present disclosure.

It is understood that additional operations can be provided before, during, and after the operations shown by FIGS. 5-6, and some of the operations described below can be replaced or eliminated, for additional embodiments of the methods.

As shown in FIG. 5, the method 300 includes operations 301-303 that are described below with reference to the computing circuit 30, the shared scale pre-process circuit 100 and the block-wise MAC circuit 200 as shown in FIGS. 3-4.

In operation 301, the shared scale pre-process circuit 100 generates a value PD_{SS} by performing an addition between a shared scales S_{X} of the block B_{X} and a shared scales S_{W} of the block B_{W}. The value PD_{SS} indicates a product between the values represented by the shared scales S_{X} and S_{W}.

For example, a first adder 101 performs an addition between the shared scales S_{X1} and S_{W1} and output the addition result as a value PD_{SS1}. The value PD_{SS1} indicates a product between a value ssv_{X1} of the shared scales S_{X1} and a value ssv_{W1} of the shared scale S_{W1} , in which the values ssv_{X1} and ssv_{W1} are similar to the value ssv described above with reference to FIG. 1.

Similarly, a second adder 101 performs an addition between the shared scales S_{X2} and S_{W2} to generate a value PD_{SS2} similar to the value PD_{SS1}.

In operation 302, the shared scale pre-process circuit 100 determines a maximum one among all the values PD_{SS} to be a max value PD_{SS-MAX}. In addition, the shared scale pre-process circuit 100 determines a difference ΔPD_{SS} between each value PD_{SS} and the max value PD_{SS-MAX}.

For example, the max circuit 102 determines the max value PD_{SS-MAX} among the values PD_{SS1} and PD_{SS2}.

In some embodiments, the max circuit 102 includes at least one subtractor that determines a difference ΔPD_{SS1} between the PD_{SS1} and the max value PD_{SS-MAX}, and determines a difference ΔPD_{SS2} between the PD_{SS2} and the max value PD_{SS-MAX}.

In operation 303, the shared scale pre-process circuit 100 compares the max value PD_{SS-MAX} with a pre-defined threshold value PD_{SS-TH}. When the max value PD_{SS-MAX} is greater than the threshold value PD_{SS-TH}, the shared scale pre-process circuit 100 determines that the products between the values represented by the shared scales S_{X} and S_{W} have a high variance. Then, the shared scale pre-process circuit 100 generates the flag VF indicating the high variance.

On the contrary, when the max value PD_{SS-MAX} is not greater than the threshold value PD_{SS-TH}, the shared scale pre-process circuit 100 determines that the products between the values represented by the shared scales S_{X} and S_{W} have a low variance. Then, the shared scale pre-process circuit 100 generates the flag VF indicating the low variance.

In some embodiment, the flag VF has a first logic value (e.g., a bit zero) to indicate the low variance, and has a second logic value (e.g., a bit one) inverted to the first logic value to indicate the high variance.

For example, the max circuit 102 further includes a comparator that compares the max value PD_{SS-MAX} and the threshold value PD_{SS-TH} to generate the flag VF.

In some embodiments, the max circuit 102 outputs the differences ΔPD_{SS1} and ΔPD_{SS2}, the max value PD_{SS-MAX} and the flag VF to the register 103. Then, the register 103 stores the differences ΔPD_{SS1} and ΔPD_{SS2}, the max value PD_{SS-MAX} and the flag VF.

As shown in FIG. 6, the method 400 for operating the block-wise MAC circuit 200 includes operations 401-406 that are described below with reference to the computing circuit 30, the shared scale pre-process circuit 100 and the block-wise MAC circuit 200 as shown in FIGS. 3-4.

In some embodiments, the block-wise MAC circuit 200 add exponents E_{X} of the block B_{X} and exponents E_{W} of the block B_{W} to generate values PD_{E}. The value PD_{E} indicates a product between a value ev_{X} of the exponents E_{X} and a value ev_{W} of the exponents E_{W}, in which the values ev_{X} and ev_{W} are similar to the value ev described above with reference to FIG. 1.

For example, the adder 211 performs an addition between the exponent E_{X1}[1] and E_{W1}[1] and output the addition result as a value PD_{E1}[1]. Similarly, the exponent E_{X1}[2] to E_{X1}[n], E_{W1}[1] to E_{W1}[n], E_{X2}[1] to E_{X2}[n] and E_{W2}[1] to E_{W2}[n] are added by the adders 211 to generate values PD_{E1}[2] to PD_{E1}[n] and PD_{E2}[1] to PD_{E2}[n].

In some embodiments, the block-wise MAC circuit 200 determines a max value PD_{E-MAX} among all the values PD_{E}.

For example, the max circuit 212 in the partial MAC circuit 210a determines a maximum one among all the values PD_{E1}[1] to PD_{E1}[n] to be a max value PD_{E-MAX1}.

In some embodiments, the block-wise MAC circuit 200 determines a difference ΔPD_{E} between each value PD_{E} and the max value PD_{E-MAX}.

For example, the max circuit 212 in the partial MAC circuit 210a includes at least one subtractor that generate a difference ΔPD_{E1}[1] between the value PD_{E1}[1] and the max value PD_{E-MAX1}, a difference ΔPD_{E1}[2] between the value PD_{E1}[2] and the max value PD_{E-MAX1}, and so on.

In addition, the max circuit 212 in the partial MAC circuit 210b generates a max value PD_{E-MAX2} and differences ΔPD_{E2}[1] to ΔPD_{E2}[n] in a manner similar to that of the max circuit 212 in the partial MAC circuit 210a generating the max value PD_{E-MAX1} and differences ΔPD_{E1}[1] to ΔPD_{E1}[n].

As shown in FIG. 6, when the flag VF indicates the high variance, the block-wise MAC circuit 200 performs operation 401. On the contrary, when the flag VF indicates the low variance, the block-wise MAC circuit 200 performs operation 402.

In operation 401, the block-wise MAC circuit 200 align a mantissa M_{X} of the B_{X} by an addition of the difference ΔPD_{SS} and the difference ΔPD_{E} to generate an aligned mantissa M_{AL_X}.

For example, the align circuit 213 aligns the mantissa M_{X1}[1] by the difference ΔPD_{SS1} from the register 103 and the difference ΔPD_{E1}[1] and output the aligned result as an aligned mantissa M_{AL_X1}[1]. Specifically, the align circuit 213 right shifts (moving bits toward the side of the least significant bit) the bits of the mantissa M_{X1}[1] by a number of bit, in which the number equals the value of the difference ΔPD_{E1}[1] plus the difference ΔPD_{E1}[1] (ΔPD_{E1}[1]+ΔPD_{E1}[1]). The align circuits 213 also generate aligned mantissa M_{AL_X1}[2] to M_{AL_X1}[n] and M_{AL_X2}[1] to M_{AL_X2}[n] in a similar manner.

In operation 402, the block-wise MAC circuit 200 align the mantissa M_{X} of the B_{X} only by the difference ΔPD_{E} to generate an aligned mantissa M_{AL_X}.

For example, the align circuit 213 aligns the mantissa M_{X1}[1] by the difference ΔPD_{E1}[1] and outputs the align result as an aligned mantissa M_{AL_X1}[1]. Specifically, the align circuit 213 right shifts (moving bits toward the side of the least significant bit) the bits of the mantissa M_{X1}[1] by a number of bit, in which the number equals the value of the difference ΔPD_{E1}[1]. The align circuits 213 also generate aligned mantissa M_{AL_X1}[2] to M_{AL_X1}[n] and M_{AL_X2}[1] to M_{AL_X2}[n] in a similar manner.

In operation 403, the block-wise MAC circuit 200 performs a normal MAC operation between the aligned mantissas M_{AL_X} and mantissas M_{W} of the block B_{W} to generate a partial MAC result pMACV.

For example, the multiply circuit 214 performs a multiplication between the aligned mantissa M_{AL_X1}[1] and the mantissa M_{W1}[1]. The aligned mantissas M_{AL_X1}[2] to M_{AL_X1}[n], the mantissa M_{W1}[2] to M_{W1}[n], the aligned mantissas M_{AL_X2}[1] to M_{AL_X2}[n], the mantissa M_{W2}[1] to M_{W2}[n] are also multiplied by the multiply circuits 214 in a similar manner.

Then, the add circuit 215 in the partial MAC circuit 210a adds all the multiplication results of the aligned mantissas M_{AL_X1}[1] to M_{AL_X1}[n], the mantissa M_{W1}[1] to M_{W1}[n] and outputs the addition result as a partial MAC result pMACV₁.

The add circuit 215 in the partial MAC circuit 210b adds all the multiplication results of the aligned mantissas M_{AL_X2}[1] to M_{AL_X2}[n], the mantissa M_{W2}[1] to M_{W2}[n] and outputs the addition result as a partial MAC result pMACV₂.

According to some embodiments, the multiply circuits 214 and the add circuit 215 in a partial MAC circuit forms a normal MAC circuit that perform MAC operations of integer and/or floating-point.

As shown in FIG. 6, when the flag VF indicates the high variance, the block-wise MAC circuit 200 performs operation 404 after operation 403. On the contrary, when the flag VF indicates the low variance, the block-wise MAC circuit 200 performs operation 405 after operation 403.

In operation 404, the block-wise MAC circuit 200 performs no alignment to the partial MAC result pMACV.

For example, when the flag VF indicates the high variance, the shift circuit 216 in the partial MAC circuit 210a does not shift the partial MAC result pMACV₁ according to the difference ΔPD_{SS1} from the register 103. The shift circuit 216 in the partial MAC circuit 210b does not shift the partial MAC result pMACV₂ according to the difference ΔPD_{SS2} from the register 103.

In operation 405, the block-wise MAC circuit 200 performs an alignment to the partial MAC result pMACV by the difference ΔPD_{SS}.

For example, when the flag VF indicates the low variance, the shift circuit 216 in the partial MAC circuit 210a right shifts the partial MAC result pMACV₁ by a bit number, in which the bit number equals the value of the difference ΔPD_{SS1} from the register 103. The shift circuit 216 in the partial MAC circuit 210b right shifts the partial MAC result pMACV₂ by a bit number, in which the bit number equals the value of the difference ΔPD_{SS2} from the register 103.

In operation 406, the block-wise MAC circuit 200 further performs an alignment to the partial MAC result pMACV by the max value PD_{E-MAX} and the difference ΔPD_{SS-MAX}.

For example, the shift circuit 216 in the partial MAC circuit 210a further right shifts the partial MAC result pMACV₁ by a bit number, in which the bit number equals the value of an addition of the max value PD_{E-MAX1} from the max circuit 212 and the difference ΔPD_{SS-MAX1} from the register 103. The shift circuit 216 in the partial MAC circuit 210b further right shifts the partial MAC result pMACV₂ by a bit number, in which the bit number equals the value of an addition of the max value PD_{E-MAX2} from the max circuit 212 and the difference ΔPD_{SS-MAX2} from the register 103.

Generally, when the flag VF indicates the high variance, the shift circuit 216 in the partial MAC circuit 210a right shifts the partial MAC result pMACV₁ according to the addition of the max value PD_{E-MAX1} and the difference ΔPD_{SS-MAX1} and outputs the shift result as an aligned partial MAC result pMACAL₁.

When the flag VF indicates the low variance, the shift circuit 216 in the partial MAC circuit 210a right shifts the partial MAC result pMACV₁ according to the addition of the the difference ΔPD_{SS1}, the max value PD_{E-MAX1} and the difference ΔPD_{SS-MAX1} and outputs the shift result as the aligned partial MAC result pMACAL₁.

In addition, the shift circuit 216 in the partial MAC circuit 210b generates an aligned partial MAC result pMACAL₂ in a similar manner.

In some embodiments, the block-wise MAC circuit 200 combines all partial MAC pMACVs after alignments to generate the MAC result MACV.

For example, the accumulate circuit 220 accumulates the aligned partial MAC results pMACAL₁ and pMACAL₂ and outputs the accumulation result as the MAC result MACV.

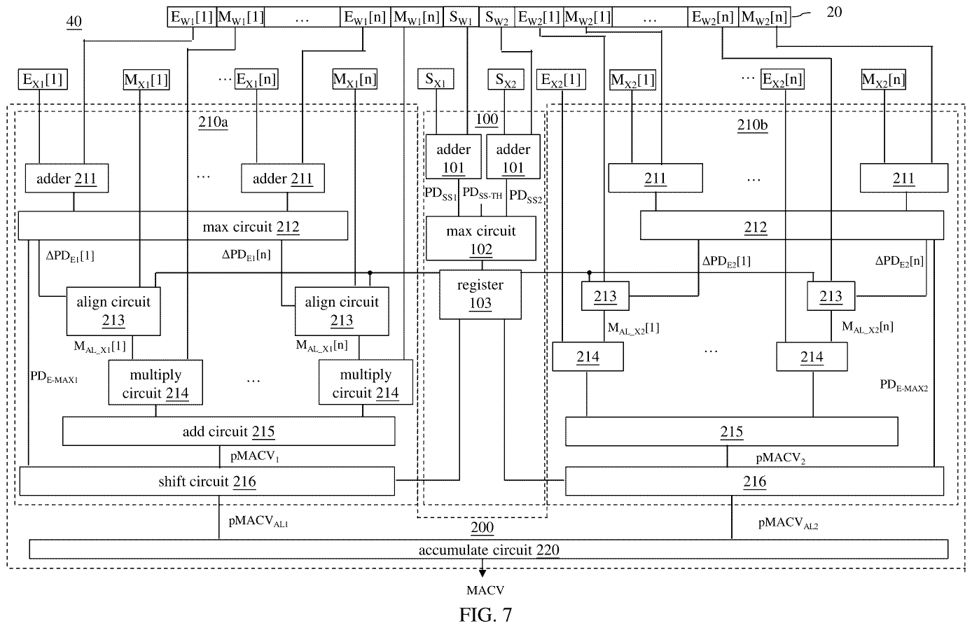

Reference is now made to FIG. 7. FIG. 7 is a schematic diagram of an example of a computing circuit 40 configured with respect to the computing circuit 30 in FIGS. 2-6, in accordance with various embodiments of the present disclosure.

Compared with the computing circuit 30 in FIG. 4, in the computing circuit 40 in FIG. 7, the shared scales S_{W1} and S_{W2}, the exponents E_{W1}[1] to E_{W1}[n], the mantissas M_{W1}[1] to M_{W1}[n], the exponents E_{W2}[1] to E_{W2}[n] and the mantissas M_{W2}[1] to M_{W2}[n] are stored in the memory 20. The memory 20 is coupled to the adders 101, 211 and the multiply circuits 214 to transfer the shared scales S_{W1} and S_{W2} , the exponents E_{W1}[1] to E_{W1}[n], the mantissas M_{W1}[1] to M_{W1}[n], the exponents E_{W2}[1] to E_{W2}[n] and the mantissas M_{W2}[1] to M_{W2}[n].

In some embodiments, the adders 211 and the align circuits 213 receive the exponents E_{X1}[1] to E_{X1}[n], the mantissas M_{X1}[1] to M_{X1}[n], the exponents E_{X2}[1] to E_{X2}[n] and the mantissas M_{X2}[1] to M_{X2}[n] from the outside of the AI accelerator 10.

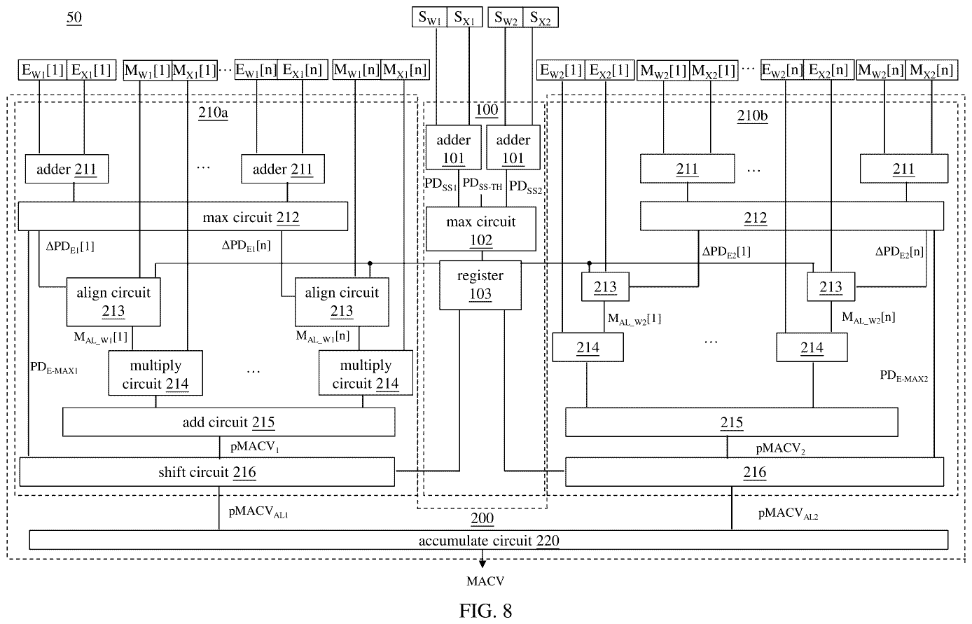

Reference is now made to FIG. 8. FIG. 8 is a schematic diagram of an example of a computing circuit 50 configured with respect to the computing circuits 30 and 40 in FIGS. 2-7, in accordance with various embodiments of the present disclosure.

Compared with the computing circuits 30 and 40 in FIGS. 4-7, in the computing circuit 50 in FIG. 8, the alignments are applied to the mantissas of the block of weight, e.g., the mantissa M_{W1}[1] to M_{W1}[n] and the mantissa M_{W2}[1] to M_{W2}[n]. The operations. For example, in operation 401, the align circuit 213 aligns the mantissa M_{W1}[1] by the difference ΔPD_{SS1} from the register 103 and the difference ΔPD_{E1}[1] to generate an aligned mantissa M_{AL_W1}[1].

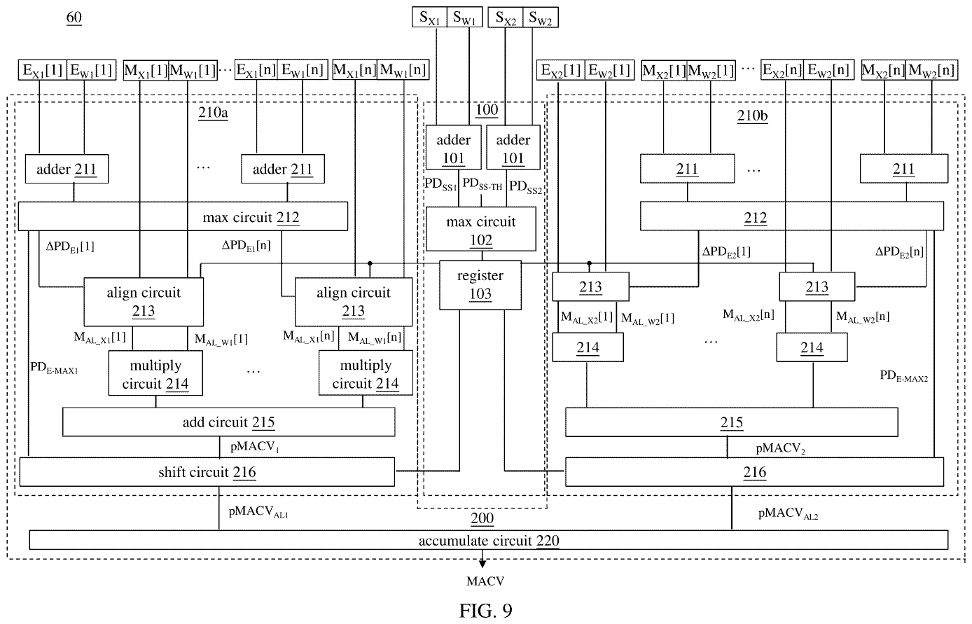

Reference is now made to FIG. 9. FIG. 9 is a schematic diagram of an example of a computing circuit 60 configured with respect to the computing circuits 30 and 40 in FIGS. 2-7, in accordance with various embodiments of the present disclosure.

Compared with the computing circuits 30 and 40 in FIGS. 4-7, in the computing circuit 60 in FIG. 9, the alignments are applied to the mantissas of the input block and the mantissas of the weight block.

For example, in operation 401, the align circuit 213 right shifts the mantissa M_{X1}[1] by the a bit number of “ΔPD_{SS1}+ΔPD_{E1}[1]−J”, and right shifts the mantissa M_{W1}[1] by the a bit number of “J”, in which “J” is a positive integer smaller than “ΔPD_{SS1}+ΔPD_{E1}[1]”. The other mantissas are shifted in a similar manner.

In operation 402, the align circuit 213 right shifts the mantissa M_{X1}[1] by the a bit number of “ΔPD_{E1}[1]−J”, and right shifts the mantissa M_{W1}[1] by the a bit number of “J”. The other mantissas are shifted in a similar manner.

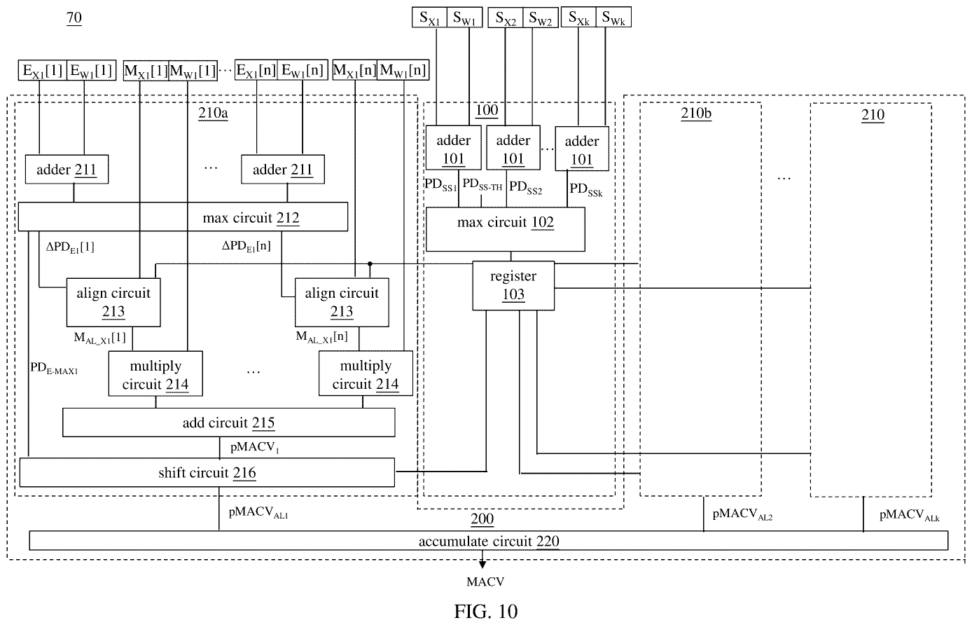

Reference is now made to FIG. 10. FIG. 10 is a schematic diagram of an example of a computing circuit 70 configured with respect to the computing circuits 30 to 60 in FIGS. 2-9, in accordance with various embodiments of the present disclosure.

Compared with the computing circuits 30 to 60 in FIGS. 4-9, the computing circuit 70 in FIG. 10 performs block-wise MAC operation of “k” blocks B_{X1} to B_{Xk} and “k” blocks B_{W1} to B_{Wk}, in which k is an integer greater than two.

As shown in FIG. 10, the computing circuit 70 includes “k” adders 101 and “k-2” partial MAC circuits 210 for generating aligned partial MAC results pMACV_{AL3} to pMACV_{ALk}. The partial MAC circuits 210 in FIG. 7 are similar to the partial MAC circuits 210a and 210b.

The computing circuit 70 is operated in a manner similar to that of operating the computing circuits 30-60. For example, in operation 302, the max circuit 102 determines the max value PD_{SS-MAX} among the values PD_{SS1} to PD_{SSk}.

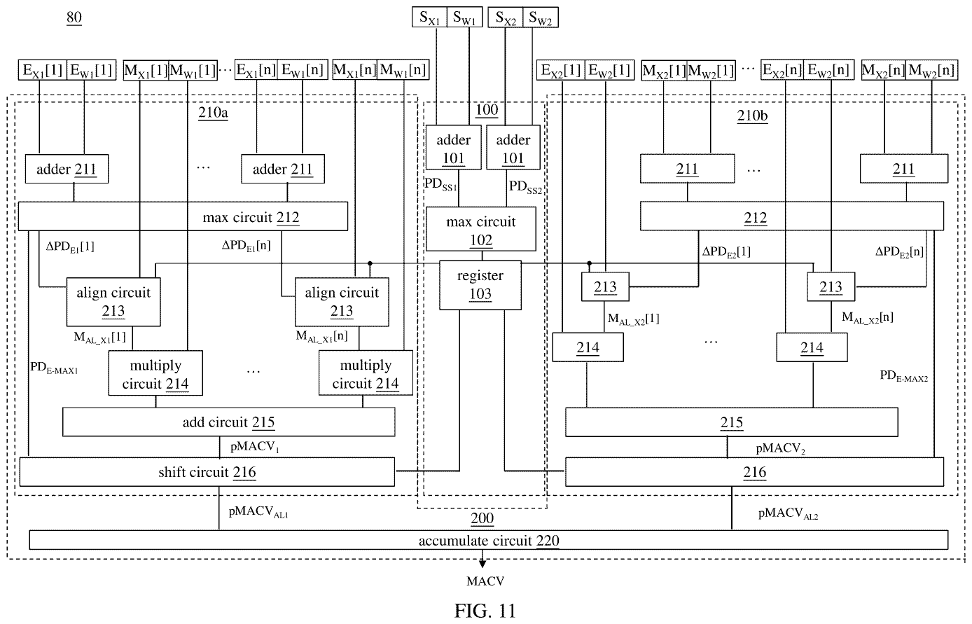

Reference is now made to FIG. 11. FIG. 11 is a schematic diagram of an example of a computing circuit 80 configured with respect to the computing circuits 30 to 70 in FIGS. 2-10, in accordance with various embodiments of the present disclosure.

Compared with the computing circuits 30 to 60 in FIGS. 4-10, the computing circuit 80 in FIG. 10 does not receive the threshold value PD_{SS-TH} and does not perform operations 303, 402 and 405. In other words, the computing circuit 80 performs only the operations corresponding to the high variance without determining whether the variance is high or low.

The configurations of FIGS. 1-11 are given for illustrative purposes. Various implements are within the contemplated scope of the present disclosure. For example, the computing circuits 30-60, 80 can have multiple partial MAC circuits 210 as shown in the computing circuit 70.

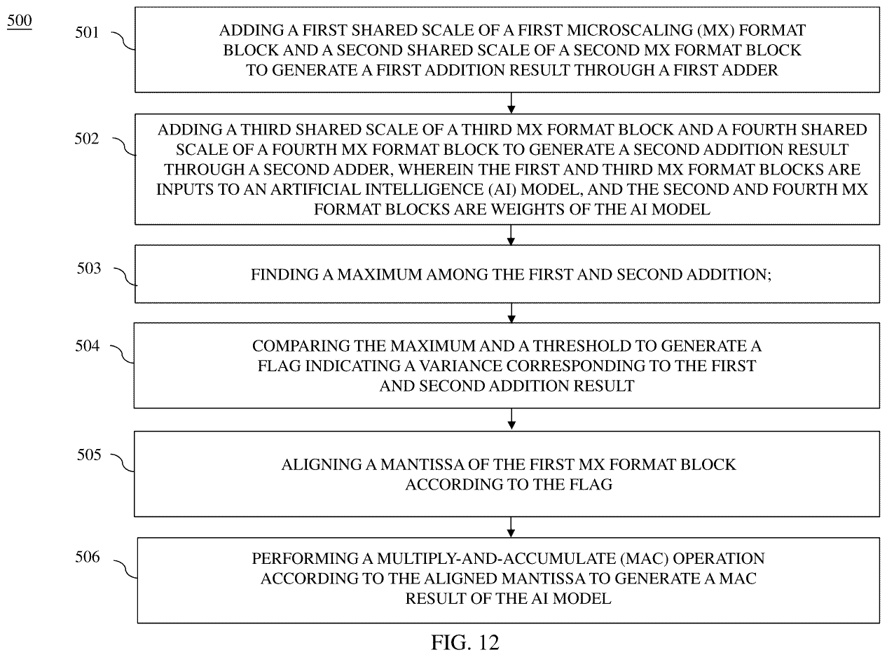

Reference is now made to FIG. 12. FIG. 12 is a flowchart diagram of a method 500 for operating the AI accelerator 10 and the computing circuits 30-80 in FIGS. 2-11, in accordance with some embodiments of the present disclosure. It is understood that additional operations can be provided before, during, and after the operations shown by FIG. 12, and some of the operations described below can be replaced or eliminated, for additional embodiments of the method. The order of the operations may be interchangeable. The method 500 includes operations 501-506 that are described below with reference to the AI accelerator 10, and the computing circuits 30-80 as shown in FIGS. 2-11.

In operations 501, the adder 101 adds the shared scale S_{X1} of the block B_{X1} and the shared scale S_{W1} of the block B_{W1} to generate the value PD_{SS1}.

In operation 502, the adder 101 adds the shared scale S_{X2} of the block B_{X2} and the shared scale S_{W2} of the block B_{W2} to generate the value PD_{SS2}. The blocks B_{X1} and B_{X2} are inputs to the model. The blocks B_{W1} and B_{W2} are weights of the model.

In operation 503, the max circuit 102 finds the max value PD_{SS-MAX} among the values PD_{SS1} and PD_{SS1}.

In operation 504, the max circuit 102 compares the max value PD_{SS-MAX} and the threshold value PD_{SS-TH} to generate the flag VF indicating a variance of corresponding to the values PD_{SS1} and PD_{SS1}.

In operation 505, the align circuit 213 aligns the mantissa M_{X1}[1] according to the flag VF to generate the aligned mantissa M_{AL_X1}+[1].

In some embodiments, the align circuit 213 aligns the mantissa M_{X1}[1] according to the difference ΔPD_{SS1} when the flag indicates the variance being high.

In operation 506, the block-wise MAC circuit 200 performs a MAC operation according to the aligned mantissa M_{AL_X1}+[1] to generate the MAC result MACV.

As described above, an AI accelerator supporting the MX format and methods for operating the AI accelerator are provided. The AI accelerator and the methods adjust where a mantissa alignment occurs in an AI operation flow to reduce compute energy through leveraging shared scale pre-process results. Compared to some approaches, the AI accelerator and the methods reduce MAC energy by about 23% and 29% for two different AI models while the area cost is small.

In some embodiments, a circuit is provided. The circuit comprises a shared scale pre-process circuit, a first partial multiply-and-accumulate (MAC) circuit, a second partial MAC circuit and an accumulate circuit. The shared scale pre-process circuit comprises first adders configured to performs first additions between a plurality of shared scales of inputs and weights, in which the shared scale pre-process circuit generates a flag indicating a variance corresponding to results of the first additions. The first partial MAC circuit performs first mantissa alignments according to the flag for generating a first partial MAC result. The second partial MAC circuit performs second mantissa alignments according to the flag for generating a second partial MAC result. The accumulate circuit accumulates the first and second partial MAC results to generate a MAC result.

In some embodiments, the shared scale pre-process circuit further comprises a max circuit configured to determine a maximum among the results of the first additions. The max circuit compares a threshold and the maximum to generate the flag.

In some embodiments, the max circuit comprises a subtractor configured to generate first differences between the results of the first additions and the maximum. The circuit further comprises a register coupled to the max circuit and configured to store the flag, the maximum and the differences.

In some embodiments, the first partial MAC circuit comprises second adders and a first max circuit. The second adders perform second additions between exponents of the inputs and the weights. The first max circuit is coupled to the second adders and determines a greatest one among the results of the second additions as a first maximum.

In some embodiments, the first partial MAC circuit further comprises align circuits configured to right shift bits of mantissas of the inputs according to the flag.

In some embodiments, the first max circuit comprises a subtractor configured to generate first differences between the results of the second additions and the first maximum. When the flag indicating the variance to be low, the align circuits right shifts the bits of the mantissas of the inputs according to the first differences.

In some embodiments, the shared scale pre-process circuit is further configured to: determine a greatest one among the results of the first additions as a second maximum; and generate first differences between the results of the first additions and the second maximum. When the flag indicating the variance to be high, the align circuits right shifts the bits of the mantissas of the inputs according to the first differences.

In some embodiments, the first partial MAC circuit further comprises multiply circuits and an add circuit. The multiply circuits perform multiplications between the alignment results of the align circuits and mantissas of the weights. The add circuit adds the multiplication results for generating the first partial MAC result.

In some embodiments, the first partial MAC circuit further comprises a shift circuit. When the flag indicating the variance to be low, the shift circuits right shifts the bits of the addition result of the add circuit according to one of the first differences.

In some embodiments, a circuit is provided. The circuit comprises a memory, a shared scale pre-process circuit, partial multiply-and-accumulate (MAC) circuit and an accumulate circuit The memory stores first microscaling (MX) format blocks of weights. The shared scale pre-process circuit coupled to the memory and configured to receive first shared scales of the first MX format blocks and second shared scales of second MX format blocks of inputs. The shared scale pre-process circuit is further configured to generate a flag that indicating a variance of products between values of the first and second shared scales. The partial MAC circuits perform mantissa alignments according to the flag for generating a plurality of partial MAC result. The accumulate circuit configured to accumulate the partial MAC results as a first MAC result.

In some embodiments, the shared scale pre-process circuit comprises adders, in which each of the adders is configured to perform an addition between one of the first shared scales and a corresponding one of the second shared scales.

In some embodiments, the shared scale pre-process circuit further comprises a max circuit configured to find a maximum among the addition results of the adders.

In some embodiments, the max circuit comprises a comparator and a subtractor. The comparator configured to compare a threshold and the maximum, wherein when the maximum is compared to be greater than the threshold, the max circuit generates the flag indicating a high variance. The subtractor generates a difference between the maximum and each of the addition results of the adders.

In some embodiments, one of the partial MAC circuits comprises an align circuit configured to align a mantissa of the inputs according to the difference when the flag indicates the high variance.

In some embodiments, one of the partial MAC circuits comprises adders configured to perform additions between exponents in a first block of the first MX format blocks and a second block of the second MX format blocks for generating a first partial MAC result of the partial MAC results.

In some embodiments, the one of the partial MAC circuits further comprises a max circuit and align circuits. The max circuit configure to find a maximum among the addition results of the adders and generate differences between the maximum and the addition results of the adders respectively. The align circuits align mantissas in the second block according to the flag and the differences.

In some embodiments, the one of the partial MAC circuits further comprises a MAC circuit configured to perform a MAC operation of the alignment results of the align circuits to generate a second MAC result.

In some embodiments, the one of the partial MAC circuits further comprises a shift circuit configured to perform a bit shift operation to the second MAC result and output a shift result as the first partial MAC result.

In some embodiments, a method is provided. The method comprises: adding a first shared scale of a first microscaling (MX) format block and a second shared scale of a second MX format block to generate a first addition result through a first adder; adding a third shared scale of a third MX format block and a fourth shared scale of a fourth MX format block to generate a second addition result through a second adder, wherein the first and third MX format blocks are inputs to an artificial intelligence (AI) model, and the second and fourth MX format blocks are weights of the AI model; finding a maximum among the first and second addition; comparing the maximum and a threshold to generate a flag indicating a variance corresponding to the first and second addition result; aligning a mantissa of the first MX format block according to the flag; and performing a multiply-and-accumulate (MAC) operation according to the aligned mantissa to generate a MAC result of the AI model.

In some embodiments, the aligning the mantissa further comprises aligning the mantissa of the first MX format block according to a difference between the first addition result and the maximum when the flag indicates the variance being high.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A circuit, comprising:
a shared scale pre-process circuit comprising:
a plurality of first adders configured to performs first additions between a plurality of shared scales of inputs and weights,
wherein the shared scale pre-process circuit is configured to generate a flag indicating a variance corresponding to results of the first additions;
a first partial multiply-and-accumulate (MAC) circuit configured to perform first mantissa alignments according to the flag for generating a first partial MAC result; and
a second partial MAC circuit configured to perform second mantissa alignments according to the flag for generating a second partial MAC result; and
an accumulate circuit configured to accumulate the first and second partial MAC results to generate a MAC result.

2. The circuit of claim 1, wherein the shared scale pre-process circuit further comprises:
a max circuit configured to determine a maximum among the results of the first additions,
wherein the max circuit is further configured to compare a threshold and the maximum to generate the flag.

3. The circuit of claim 2, wherein the max circuit comprises:
a subtractor configured to generate differences between the results of the first additions and the maximum,
wherein the circuit further comprises:
a register coupled to the max circuit and configured to store the flag, the maximum and the differences.

4. The circuit of claim 1, wherein the first partial MAC circuit comprises:
a plurality of second adders configured to perform second additions between exponents of the inputs and the weights; and
a first max circuit coupled to the second adders and configured to determine a greatest one among the results of the second additions as a first maximum.

5. The circuit of claim 4, wherein the first partial MAC circuit further comprises:
a plurality of align circuits configured to right shift bits of mantissas of the inputs according to the flag.

6. The circuit of claim 5, wherein the first max circuit comprises:
a subtractor configured to generate first differences between the results of the second additions and the first maximum,
wherein when the flag indicating the variance to be low, the align circuits is further configured to right shift the bits of the mantissas of the inputs according to the first differences.

7. The circuit of claim 5, wherein the shared scale pre-process circuit is further configured to:
determine a greatest one among the results of the first additions as a second maximum; and
generate first differences between the results of the first additions and the second maximum,
wherein when the flag indicating the variance to be high, the align circuits is further configured to right shift the bits of the mantissas of the inputs according to the first differences.

8. The circuit of claim 7, wherein the first partial MAC circuit further comprises:
a plurality of multiply circuits configured to perform multiplications between the alignment results of the align circuits and mantissas of the weights; and
an add circuit configured to add the multiplication results for generating the first partial MAC result.

9. The circuit of claim 8, wherein the first partial MAC circuit further comprises:
a shift circuit, wherein when the flag indicating the variance to be low, the shift circuits is configured to right shift the bits of the addition result of the add circuit according to one of the first differences.

10. A circuit comprising:
a memory configured to store first microscaling (MX) format blocks of weights; and
a shared scale pre-process circuit coupled to the memory and configured to receive first shared scales of the first MX format blocks and second shared scales of second MX format blocks of inputs,
wherein the shared scale pre-process circuit is further configured to generate a flag that indicating a variance of products between values of the first and second shared scales;
a plurality of partial multiply-and-accumulate (MAC) circuits configured to perform mantissa alignments according to the flag for generating a plurality of partial MAC result; and
an accumulate circuit configured to accumulate the partial MAC results as a first MAC result.

11. The circuit of claim 10, wherein the shared scale pre-process circuit comprises:
a plurality of adders, wherein each of the adders is configured to perform an addition between one of the first shared scales and a corresponding one of the second shared scales.

12. The circuit of claim 11, wherein the shared scale pre-process circuit further comprises:
a max circuit configured to find a maximum among the addition results of the adders.

13. The circuit of claim 12, wherein the max circuit comprises:
a comparator configured to compare a threshold and the maximum, wherein when the maximum is compared to be greater than the threshold, the max circuit generates the flag indicating a high variance; and
a subtractor configured to generate a difference between the maximum and each of the addition results of the adders.

14. The circuit of claim 13, wherein one of the partial MAC circuits comprises:
an align circuit configured to align a mantissa of the inputs according to the difference when the flag indicates the high variance.

15. The circuit of claim 10, wherein one of the partial MAC circuits comprises:
a plurality of adders configured to perform additions between exponents in a first block of the first MX format blocks and a second block of the second MX format blocks for generating a first partial MAC result of the partial MAC results.

16. The circuit of claim 15, wherein the one of the partial MAC circuits further comprises:
a max circuit configure to find a maximum among the addition results of the adders and generate differences between the maximum and the addition results of the adders respectively; and
a plurality of align circuits configured to align mantissas in the second block according to the flag and the differences.

17. The circuit of claim 16, wherein the one of the partial MAC circuits further comprises:
a MAC circuit configured to perform a MAC operation of the alignment results of the align circuits to generate a second MAC result.

18. The circuit of claim 17, wherein the one of the partial MAC circuits further comprises:
a shift circuit configured to perform a bit shift operation to the second MAC result and output a shift result as the first partial MAC result.

19. A method, comprising:
adding a first shared scale of a first microscaling (MX) format block and a second shared scale of a second MX format block to generate a first addition result through a first adder;
adding a third shared scale of a third MX format block and a fourth shared scale of a fourth MX format block to generate a second addition result through a second adder, wherein the first and third MX format blocks are inputs, and the second and fourth MX format blocks are weights;
finding a maximum among the first and second addition;
comparing the maximum and a threshold to generate a flag indicating a variance corresponding to the first and second addition result;
aligning a mantissa of the first MX format block according to the flag; and
performing a multiply-and-accumulate (MAC) operation according to the aligned mantissa to generate a MAC result between the inputs and the weights.

20. The method of claim 19, wherein the aligning the mantissa further comprises:
aligning the mantissa of the first MX format block according to a difference between the first addition result and the maximum when the flag indicates the variance being high.
